(19) United States
(12) Patent Application Publication
(10) Pub. No.: US 2011/0161388 A1
(43) Pub. Date: Jun. 30, 2011

(54) INFORMATION PROCESSING APPARATUS AND METHOD OF CONTROLLING SAME

(75) Inventor: Koji Inose, Saitama-shi (JP)

(73) Assignee: CANON KABUSHIKI KAISHA, Tokyo (JP)

(21) Appl. No.: 12/948,291

(22) Filed: Nov. 17, 2010

(30) Foreign Application Priority Data
Dec. 28, 2009 (JP) 2009-298829

(51) Int. Cl. G06F 17/30; G06F 15/16

(52) U.S. Cl. 707/827; 707/E17.01

(57) ABSTRACT

An information processing apparatus according to the present invention includes an acquisition unit for acquiring the name of a file to be transmitted to a server; a determination unit for determining, in a case where the server has received a file having a name identical with that of a file that has already been saved in the server, whether it is possible to save the received file in a condition distinguished from the already saved file; and a control unit for controlling, in a case where the determination unit determines that it is possible to save the received file in a condition distinguished from the already saved file, so that the name of the file that has been acquired by the acquisition unit is transmitted, without being changed, to the server together with the file to be transmitted.

### BACKGROUND OF THE INVENTION

1. Field of the Invention

The present invention relates to an information processing apparatus, in order to save a file in a server, which transmits the file and its name to the server, and to a method of controlling this apparatus.

2. Description of the Related Art

When a file is transmitted from an information processing apparatus (an apparatus such as an MFP or personal computer, by way of example) to a server and the file is saved in the server, there is a technique that prevents the overwriting of a file in a case where a file having the same name as that of a file that was saved by the information processing apparatus, which already exists in the server. This technique involves changing the name of the file already existing in the server, or changing the name of the file that is to be saved in the server, in accordance with a predetermined rule, in such a manner that the name will be identifiable by the user.

For example, according to a technique described in the specification of Japanese Patent Laid-Open No. 5-108436 (Document 1), if a file having the same name as the name of a file that has been received from an information processing apparatus already exists in a server, the name of the file already saved in the server is changed, on the server side, to a name having a record of being named in the past, in such a manner that the name will not duplicate the name of the newly received file, thereby avoiding overwriting of the file.

Further, with personal-computer-based management document servers growing in popularity as a file storage destination, overwriting is avoided by assigning a version number to a newly received file having an identical name, thereby saving the file by distinguishing it from an already saved file, or by excluding a storage command from a different user to thereby refuse saving of the file.

However, in accordance with Document 1, the number of names for which there is a record of naming is finite. As a consequence, it is difficult to change the name of a file that has already been saved in a server so as not to duplicate the name of a newly received file. Further, in a case where a server has been set to assign a version number to a file newly received by the server, it is possible to prevent overwriting. However, if the server does not have such a setting, overwriting of a file cannot be prevented.

### SUMMARY OF THE INVENTION

The present invention has been devised in view of the foregoing problems and provides an information processing apparatus and method of controlling the same in which, if a server receives a file whose content is different from but whose name is the same as a file already saved, it is possible to avoid, with greater reliability, the overwriting of the already saved file by a newly received file.

According to one aspect of the present invention, there is provided an information processing apparatus, in order to save a file in a server, which transmits the file and name thereof to the server, the apparatus comprises: an acquisition unit configured to acquire the name of the file to be transmitted to the server; a determination unit configured to determine, in a case where the server has received a file having a name identical with that of a file that has already been saved in the server, whether it is possible to save the received file in a condition distinguished from the already saved file; and a control unit configured to control, in a case where the determination unit determines that it is possible to save the received file in a condition distinguished from the already saved file, so that the name of the file that has been acquired by the acquisition unit is transmitted, without being changed, to the server together with the file to be transmitted.

According to another aspect of the present invention, there is provided a method of controlling an information processing apparatus, in order to save a file in a server, which transmits the file and name thereof to the server, the method comprises: an acquisition step of acquiring the name of the file to be transmitted to the server; a determination step of determining, in a case where the server has received a file having a name identical with that of a file that has already been saved in the server, whether it is possible to save the received file in a condition distinguished from the already saved file; and a control step of controlling, in a case where it is determined at the determination step that it is possible to save the received file in a condition distinguished from the already saved file, so that the name of the file that has been acquired at the acquisition step is transmitted, without being changed, to the server together with the file to be transmitted.

In accordance with the present invention, there can be provided an information processing apparatus and method of controlling the same in which, if a server receives a file whose content is different from but whose name is the same as a file already saved, it is possible to avoid, with greater reliability, the overwriting of the already saved file by a newly received file.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, and serve to explain the principles of the invention.

FIG. 1 is a diagram illustrating the configuration of an information processing system according to a first embodiment of the present invention;

FIG. 2 is a diagram illustrating the configuration of an information processing apparatus;

FIG. 3 is a diagram illustrating the configuration of an application program module;

FIG. 4 is a diagram illustrating exclusion processing according to a first embodiment of the present invention;

FIG. 5 is a diagram illustrating exclusion processing according to a modification of the first embodiment; and

FIG. 6 is a diagram illustrating an example of a user interface of an information processing apparatus.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

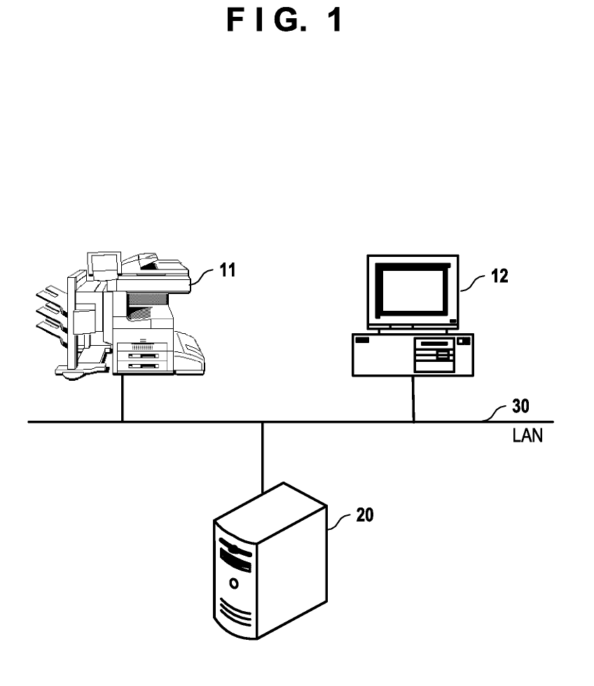

### First Embodiment

[Configuration of Information Processing System (FIG. 1, 2)]

This information processing system includes a server (server computer) 20 for storing files; an information processing apparatus (an MFP, for example) 11 serving as a client computer for transmitting a file and the name thereof to the server 20 in order to save the file in the server 20; and an information processing apparatus (a personal computer, for example) 12 different from the information processing apparatus 11. The information processing apparatuses 11, 12 are connected to the server 20 via a LAN 30. In the description that follows, it will be assumed in this embodiment that the information processing apparatus 11 is the information processing apparatus of the present invention. However, the description holds true for the information processing apparatus 12 as well.

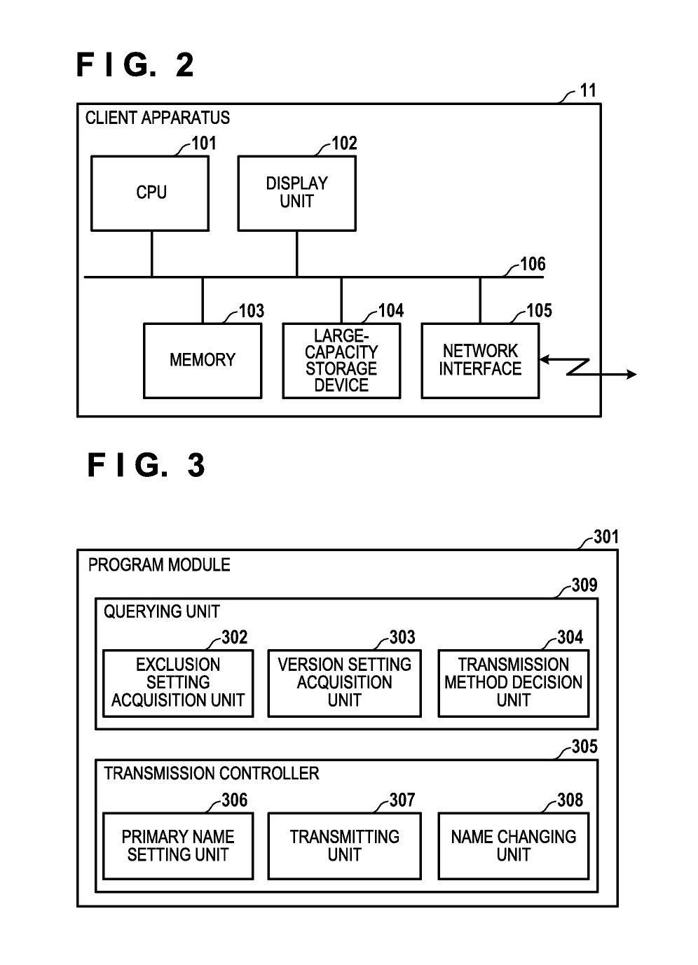

The information processing apparatus 11 has the configuration shown in FIG. 2. A CPU 101 is connected to various functions/devices via an internal bus 106 and controls the overall information processing apparatus 11. A display unit 102 displays a GUI (Graphical User Interface) on a touch-sensitive panel (control panel) or the like. The user performs desired operations via this GUI displayed on the display unit 102.

The memory 103 stores various instructions (a program) by which the CPU 101 controls the overall information processing apparatus 11. A large-capacity storage device 104 stores the program itself and files and the like to be transmitted to the server 20.

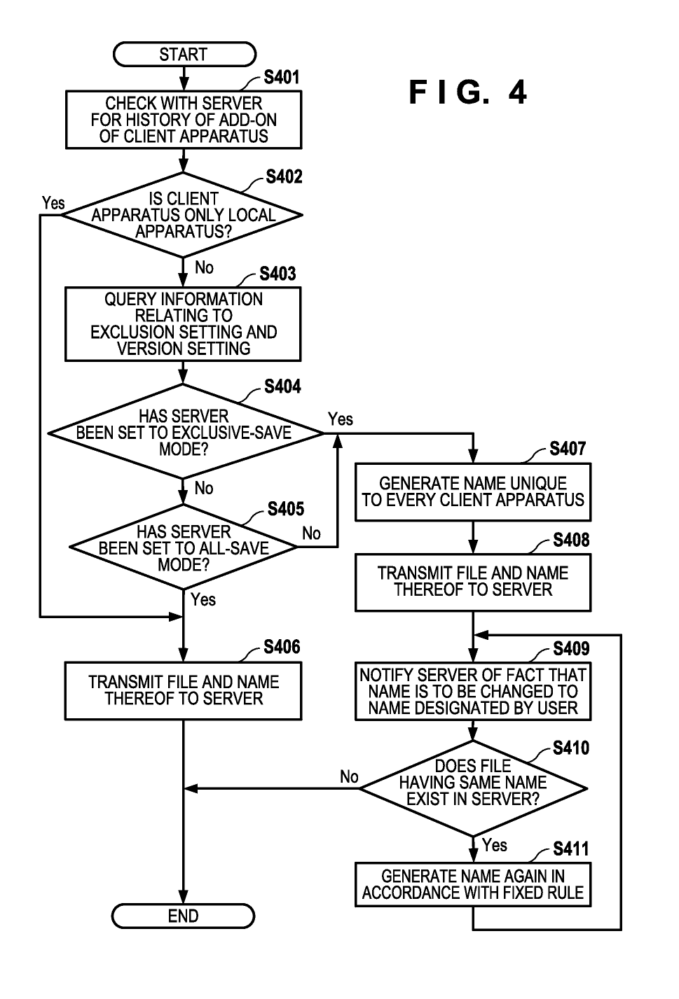

A network interface 105 receives and transmits a signal through the LAN 30 in accordance with the instruction from the CPU 101. The network interface 105 is used in order to communicate between the server 20 and information processing apparatus 11.

[Configuration of Program Module (FIG. 3)]

A program module 301, which has been stored in the large-capacity storage device 104 of information processing apparatus 11, has a querying unit 309 and a transmission controller 305.

In a case where the server has received a file whose content is different from but whose name is the same as a file already saved, the querying unit 309 queries the server as to whether it has been set to an overwrite-save mode (first save mode) in which the already saved file is replaced with the received file; an exclusion-save mode (second save mode) in which the received file is not saved; and an all-save mode (third save mode) in which by assigning an identifier to the name of the received file, it is saved in a manner making it identifiable (distinguishable) from an already saved file.

More specifically, the querying unit 309 includes an exclusion setting acquisition unit 302, a version setting acquisition unit 303 and a transmission method decision unit 304.

In a case where the server 20 has received a plurality of files of different content but of the same name owing to commands from multiple users, the exclusion setting acquisition unit 302 acquires from the server 20 information as to whether the server has a setting indicating either the exclusion-save mode or the overwrite-save mode, and, if the server has such a setting, the contents of the setting.

The version setting acquisition unit 303 acquires from the server 20 information as to whether the server has a setting indicating either the all-save mode or the overwrite-save mode, and, if the server has such a setting, the contents of the setting.

The transmission method decision unit 304 changes over the file transmission method based upon the information acquired by the exclusion setting acquisition unit 302 and version setting acquisition unit 303 and the number of information processing apparatuses that have been connected to the server 20 via the LAN 30.

If the result of inquiry made by the querying unit 309 is that the server 20 has been set to the all-save mode, the transmission controller 305 does not change the name of the file and transmits the file and the name thereof to the server 20. On the other hand, if the server 20 has been set to the exclusion-save mode or the overwrite-save mode, then the transmission controller 305 changes the name of the file in accordance with a predetermined rule and transmits the file along with the changed name to the server 20.

More specifically, the transmission controller 305 includes a primary name setting unit 306 which, in a case where the server 20 has been set to the exclusion-save mode or the overwrite-save mode, changes the name of a file in accordance with a predetermined rule; a transmitting unit 307 for transmitting a file and the file name or the changed file name to the server 20; and a name changing unit 308 for changing the primary name of the file decided by the primary name setting unit 306 to a name designated by the user. Although the decided name can be one not identifiable by the user, the primary name setting unit 306 always decides a name unique to each information processing apparatus as the primary name. The name changing unit 308 changes the name to a name designated by the user and thus to a name identifiable by the user.

[Exclusion Processing Executed by Information Processing Apparatus 11 (FIG. 4)]

The processing illustrated in FIG. 4 is executed as a result of the CPU 101 reading in each of the components (see FIG. 3) of the program module. A file to be transmitted to the server 20 is designated in the information processing apparatus 11 by a command from the user. The file to be transmitted has already been assigned a file name managed by the file system of the information processing apparatus 11. The file name may be made a file name that will be in effect when the file is saved by the server 20 or it may be so arranged that the file name that will be in effect when the file is saved by the server 20 is designated by the user afresh. The CPU 101 of information processing apparatus 11 acquires the file name that will be in effect when the file to be transmitted to the server 20 is saved by the server 20.

In a case where the information processing apparatus 11 is a multifunction peripheral (MFP), the file that will be sent to the server 20 can be a file of image data generated as the result of a document image that has been read by a scanner possessed by the information processing apparatus 11.

First, the transmission method decision unit 304 queries the server 20 for a history of add-on of any information processing apparatus, which is capable of transmitting a file to the server 20, to the server 20 (step S401). Based upon the add-on history acquired at step S401, the transmission method decision unit 304 determines whether the information processing apparatus that is capable of transmitting a file to the server 20 is only this local apparatus (step S402). If the information processing apparatus is only this local apparatus, then the transmitting unit 307 transmits the file and the name thereof to the server 20 (step S406). The reason for this is that there is no possibility that a file transmitted from another information processing apparatus and already saved will be overwritten (replaced) by a newly received file.

On the other hand, in a case where an information processing apparatus besides the local apparatus has been connected to the server 20, the exclusion setting acquisition unit 302 and version setting acquisition unit 303 query the server 20 and acquire an indication as to whether it has an exclusion setting and a version setting as well as information relating to the contents of the setting (step S403). Here it will be assumed that if the server does not have an exclusion setting and a version setting, then overwrite-save is carried out.

In this embodiment, it is assumed that the local apparatus is the information processing apparatus 11. Since there is another apparatus in addition to the local apparatus, namely the information processing apparatus 12 that is capable of transmitting a file to the server 20, processing proceeds from step S402 to step S403.

Based upon the information acquired at step S403, the exclusion setting acquisition unit 302 determines whether the server 20 has been set to the exclusion-save mode (step S404). If the server 20 has been set to the exclusion-save mode, the primary name setting unit 306 decides, by a character string that is unique to every information processing apparatus, a name of the file that will positively succeed in being saved in the server 20 (step S407). If a MAC address is used, the file name after it is changed will be “AA-BB-CC-11-22-33-(1)”, by way of example. “AA-BB-CC-11-22-33” is a character string representing a MAC address, and “-(1)” is a serial number unique to every information processing apparatus. A character string (such as the serial number of the apparatus) other than a MAC address may be used as the character string unique to the information processing apparatus so long as the character string is information that is capable of uniquely specifying the information processing apparatus.

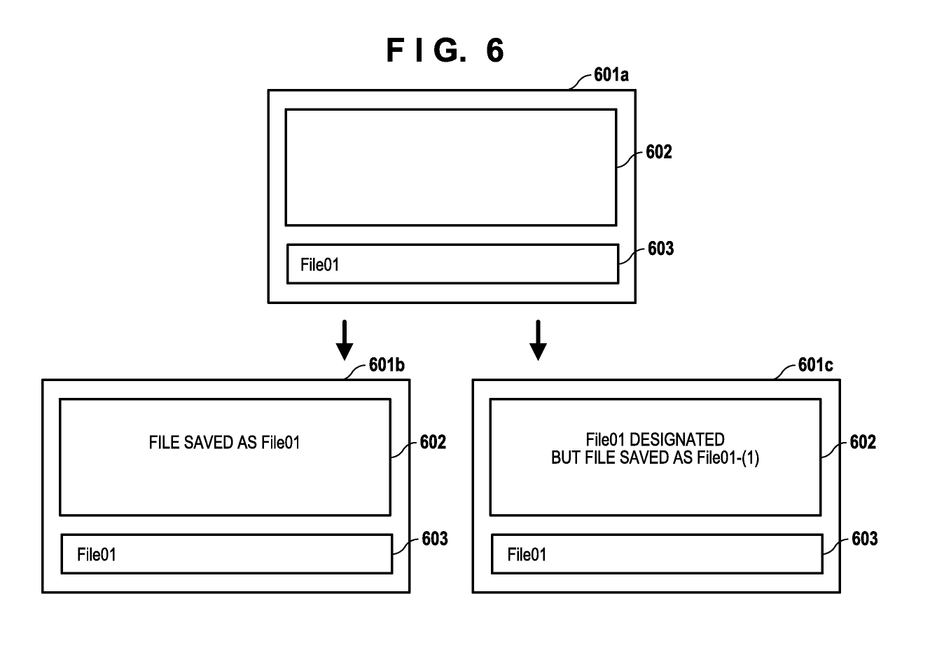

The transmitting unit 307 transmits the name decided at step S407 and the file to the server 20 (step S408). After the success of the transmit processing of step S408 is confirmed, the name changing unit 308 notifies the server 20 of the fact that the primary name decided at step S407 is to be changed to a desired name (step S409). FIG. 6 illustrates an example of a UI displayed on the display unit. Specifically, a UI 601 has an area 602 that displays a message to the user and an area 603 that accepts input of a file name from the user. If the user inputs “File01” in the area 603 as the name after the name change, as indicated at 601a, the display unit stands by, without displaying a success/failure result in the area 602, until an indication of success/failure of the name change by the server 20 is received.

Next, the name changing unit 308 determines whether the name designated by the user already exists in the server 20 (step S410). If this name does not exist in the server 20, then a comment to the effect that the file has been saved with the name designated by the user is displayed in the area 602, as indicated at 601b, and this series of processing is exited.

On the other hand, if this name exists in the server 20, then the name changing unit 308 generates a name again, in accordance with a fixed rule, within limits that allow the name to be identifiable by the user (step S411). For example, if the user designates the name “File01” and this name already exists in the server 20, then the name changing unit 308 generates a name such as “File01-(1)” and displays a comment to this effect in the area 602, as indicated at 601c. Processing then returns to step S409 and processing is repeated until the name change is realized.

If it is determined at step S404 that the server 20 has not be set to the exclusion-save mode, then, on the basis of the information acquired by the version setting acquisition unit 303 at step S403, it is determined whether the server 20 has been set to the all-save mode (step S405). If the server 20 has not been set to the all-save mode, this means that the server has been set to the remaining mode, namely the overwrite-save mode, and overwriting of an already saved file will be carried out. Consequently, processing proceeds to step S407. On the other hand, if the server 20 has been set to the all-save mode, then there is no possibility that overwrite will be performed. Hence, the file is transmitted to the server (step S406). When completion of file storage is verified, this series of processing is exited.

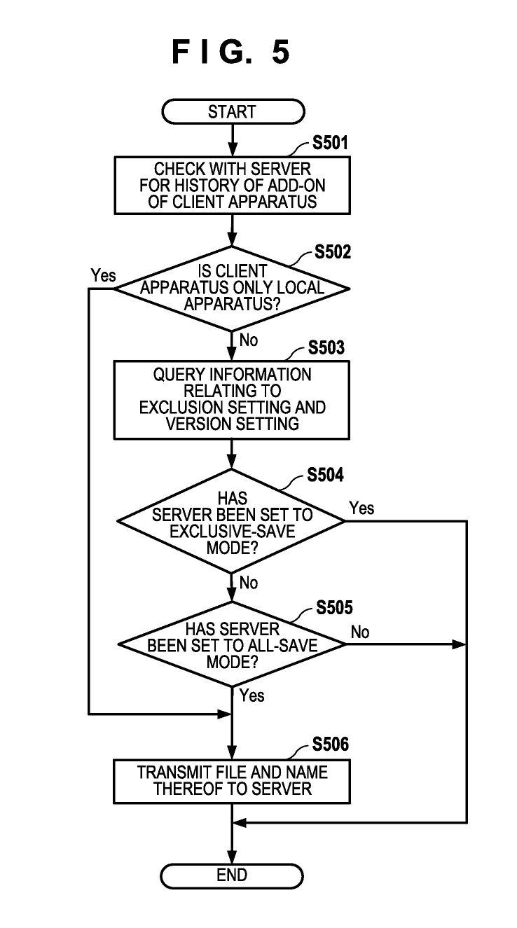

In the embodiment described above, overwriting of a file is avoided by changing the name of the file in a case where overwrite is a possibility. It may be so arranged, however, that file transmission itself is not carried out (is aborted) in such case, as illustrated in FIG. 5. Specifically, if it is determined at step S504 that the server 20 has been set to the exclusion-save mode, or if it is determined at step S505 that the server 20 has not been set to the all-save mode, then overwriting is a possibility. Therefore, transmission of the file to the server 20 is not performed and this series of processing is exited.

Thus, in accordance with this embodiment, as described above, there is provided an information processing apparatus, and a method of controlling the same, wherein if a server receives a file whose content is different from that of an already saved file but whose name is the same, overwriting of the already saved file by a newly received file can be avoided more reliably.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., a computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-298829, filed Dec. 28, 2009, which is hereby incorporated by reference herein in its entirety.

What is claimed is:

1. An information processing apparatus, in order to save a file in a server, which transmits the file and name thereof to the server, the apparatus comprising:
an acquisition unit configured to acquire the name of the file to be transmitted to the server;
a determination unit configured to determine, in a case where the server has received a file having a name identical with that of a file that has already been saved in the server, whether it is possible to save the received file in a condition distinguished from the already saved file; and
a control unit configured to control, in a case where the determination unit determines that it is possible to save the received file in a condition distinguished from the already saved file, so that the name of the file that has been acquired by the acquisition unit is transmitted, without being changed, to the server together with the file to be transmitted.

2. The apparatus according to claim 1, wherein in a case where the determination unit determines that it is not possible to save the received file in a condition distinguished from the already saved file, the control unit controls so that a file name is generated in accordance with a predetermined rule and the generated file name is transmitted to the server together with the file to be transmitted.

3. The apparatus according to claim 2, further comprising a notification unit configured to notify the server so as to change the generated name of the file, which has been transmitted to the server, to the name of the file that has been acquired by the acquisition unit.

4. The apparatus according to claim 3, wherein the file name generated in accordance with the predetermined rule includes information uniquely specifying the information processing apparatus.

5. A method of controlling an information processing apparatus, in order to save a file in a server, which transmits the file and name thereof to the server, the method comprising:
an acquisition step of acquiring the name of the file to be transmitted to the server;
a determination step of determining, in a case where the server has received a file having a name identical with that of a file that has already been saved in the server, whether it is possible to save the received file in a condition distinguished from the already saved file; and
a control step of controlling, in a case where it is determined at the determination step that it is possible to save the received file in a condition distinguished from the already saved file, so that the name of the file that has been acquired at the acquisition step is transmitted, without being changed, to the server together with the file to be transmitted.

6. A storage medium storing a program for causing a computer to function as each of the units of the information processing apparatus set forth in claim 1.
